(19) United States
(12) Patent Application Publication
(10) Pub. No.: US 2018/0207971 A1
(43) Pub. Date: Jul. 26, 2018

(54) LUSTROUS PRINT MEDIA

(71) Applicant: Hewlett-Packard Development Company, L.P., Houston, TX (US)

(72) Inventors: Xiaoqi Zhou, San Diego, CA (US); Francois K. Pirayesh, San Diego, CA (US)

(21) Appl. No.: 15/745,023

(22) PCT Filed: Oct. 19, 2015
(86) PCT No.: PCT/US15/56165

§ 371 Date: Jan. 15, 2018

(51) Int. Cl. B41M 5/50; B41M 5/52; B32B 15/08; B32B 27/20

(52) U.S. Cl. CPC B41M 5/506; B41M 5/508; B41M 5/5218; B41M 5/5245; B41M 5/5254; B32B 15/08; B32B 2559/00; B41M 5/5263; B32B 2305/30; B32B 2307/406; B32B 2250/04; B32B 2250/05; B32B 27/20

(57) ABSTRACT

Lustrous print media include: a lustrous metallic core substrate; a base layer disposed on the lustrous metallic core substrate; and an image-receiving layer disposed on the base layer. A method of fabricating the lustrous print media and a method for printing on the lustrous print media are also provided.

### BACKGROUND

Inkjet technology has expanded its application to high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of media substrates. These printable media or recording material can be cut sized sheets or commercial large format media such as banners and wallpapers. Current inkjet printing technology involves forcing the ink drops through small nozzles by thermal ejection, piezoelectric pressure or oscillation, onto the surface of such media. Within the printing method, the media substrate plays a key role in the overall image quality and permanence of the printed images.

Currently, there is a growing demand for digitally printed contents which is no longer limited to the “traditional” black-white text images and full color photo images, but extends also to prints with visual special effects such as metallic appearance and/or reflectivity, for example. Accordingly, investigations continue into developing media and/or printing methods that can be effectively used with such printing techniques, which imparts good image quality and which allow the production of specific appearances.

### BRIEF DESCRIPTION OF THE DRAWINGS

FIG. 1A depicts a cross-sectional view of a lustrous print media, according to an example.

FIG. 1B depicts a cross-sectional view of another lustrous print media, according to an example.

FIG. 2 is a flow chart depicting an example method for fabricating lustrous print media.

FIG. 3 is a flow chart depicting an example method for printing a pigment-containing inkjet ink onto lustrous print media.

### DETAILED DESCRIPTION

Reference is made now in detail to specific examples, which illustrate the best mode presently contemplated by the inventors for practicing the invention. Alternative examples are also briefly described as applicable.

Before particular examples of the present disclosure are disclosed and described, it is to be understood that the present disclosure is not limited to the particular process and materials disclosed herein. It is also to be understood that the terminology used herein is used for describing particular examples only and is not intended to be limiting, as the scope of protection will be defined by the claims and equivalents thereof In describing and claiming the present article and method, the following terminology will be used: the singular forms “a”, “an”, and “the” include plural referents unless the context clearly dictates otherwise. Thus, for example, reference to “a particle” includes reference to one or more of such materials. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to 20 wt %, but also to include individual concentrations such as 2 wt %, 3 wt %, 4 wt %, and sub-ranges such as 5 wt % to 15 wt %, 10 wt % to 20 wt %, etc. All percents are by weight (wt %) unless otherwise indicated. As another example, a range of 1 part to 20 parts should be interpreted to include not only the explicitly recited concentration limits of about 1 part to about 20 parts, but also to include individual concentrations such as 2 parts, 3 parts, 4 parts, etc. All parts are dry parts in unit weight, with the sum of the inorganic pigment equal to 100 parts, unless otherwise indicated. Furthermore, when “about” is utilized to describe a value, this is meant to encompass minor variations (up to ±10%) from the stated value.

The popularity of digital printing such as inkjet printing and electrophotographic printing is rapidly increasing. Applications range from small format desk top A size or smaller photo book size printing to large format such as wall coverings, signage, banners, and the like with the images in a form of designs, symbols, photographs, and/or text. The image-receiving media varies widely from traditional cellulose paper to plastic film, wood broad, fabric textile and others. A special area of such digital printing technology is metallic printing, where either a metallic ink, such as silver or gold particles based ink, or faux metallic ink using some metallic oxide particles to replace expensive metal powders, or metallic media such as metal foil may be used to generate the metallic appearance. The latter printing, using metallic media, may be used in many cases as it does not require special ink sets to generate a metallic appearance to maintain low operation cost, and the media itself can present some special effects which the paper or plastic media not have, such as high strength and high stiffness. These physical properties are sometime special useful in a specific application such as labeling and special high end greeting cards, wood planks, and memorable trophies.

The challenges for metallic media printing come from its intrinsic properties. Metallic media in general are not solvent-absorbing, which may make any solvent or aqueous solvent-containing ink such as inkjet ink unusable; the adhesion of the ink particles on metallic surface is not strong, which may make durability of the image such as scratch or rapping resistance poor. The extreme high light refection is also not desirable to the end user.

The present disclosure describes a metallic print media that shows desirable lustrous appearance but not too strong light reflection. The metallic print media includes a metallic foil as a core-supporting substrate and as the lustrous effects provider, and the coating layers, which play the role as image-receiving layer to create a high quality and durable images.

In accordance with the teachings herein, the print media may include a lustrous metallic core substrate, a base layer, and an image-receiving layer on one side. In an example, a laminated back supporting layer using a lamination adhesive may be formed on the backside of the print media (opposite to the print side). In another example, the media may be double-side printable media, in which the laminated back supporting layer may be replaced by an image-receiving layer having either the same composition or a different composition as the opposite image-receiving layer.

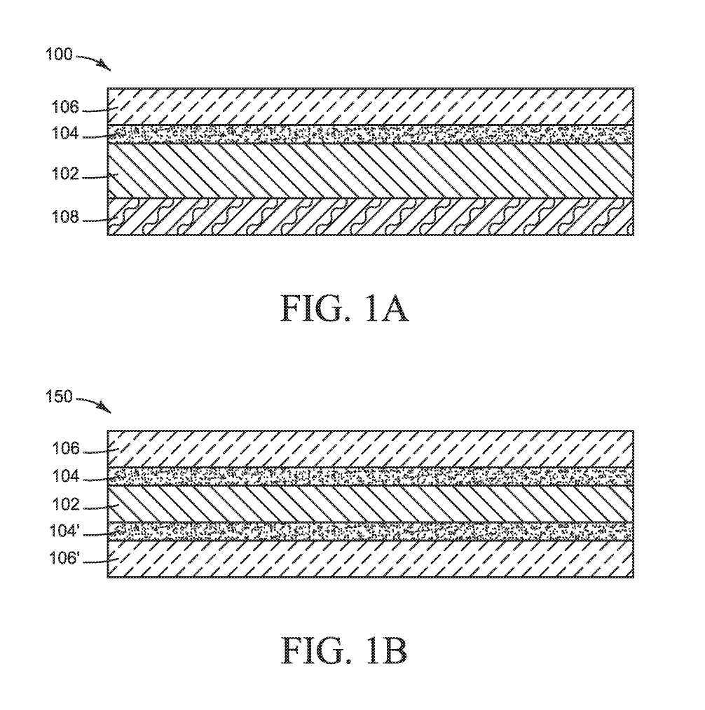

FIG. 1A depicts a cross-sectional view of the printing media 100 having the lustrous metallic core substrate 102, the base layer 104, and the image-receiving layer 106. A laminated back supporting layer 108 may be formed on the backside of the print media 100. FIG. 1B depicts an alternative configuration in which the laminated back supporting layer 108 may be replaced with a second base layer 104′ and a second image-receiving layer 106′. The two base layers 104, 104′ may be compositionally the same or different. The two image-receiving layers 106, 106′ may be compositionally the same or different.

### Lustrous Metallic Core Substrate 102:

Lustrous means herein a smooth, shiny, and bright surface. When light impinges on the lustrous metallic surface, the photons interact with the electrons in the metallic bonding. Since photons cannot penetrate very far into the metal, they are typically reflected. When they are reflected, although some may also be absorbed, all reflected photons in the visible spectrum give human beings a shiny or “lustrous” perception. The degree of lustrous perception can be expressed using terms such as “luster” or flop index. Since luster depends on the variation of lightness and reflection angle, it can be simplified, in the visible spectrum of 400 nm to 700 nm, and expressed as:

S=3(L1−L3)/L2,

where S is the measured luster, L1 is CIELAB L* measured at the aspecular angle of 15 degrees, L2 is CIELAB L* measured at the aspecular angle of 45 degrees, and L3 is CIELAB L* measured at the aspecular angle of 110 degrees.

In one example, the S value of the lustrous metallic core substrate may be greater than 6.5. In another example, the S value of the lustrous metallic core substrate may be greater than 8. And yet in another example, the S value of the lustrous metallic core substrate may be greater than 12. These values are for the lustrous metallic core substrate before adding the subsequent layers 104 and 106 (and 104′ and 106′ to the second side).

The chemical type of metal foil for the lustrous metal substrate 102 that can be selected in accordance with the present teachings is not limited. Any metal in the chemical Periodic Table from Groups IB to VIIB and VIII, and their alloys, can be selected. For example, aluminum, copper, stainless steel, nickel, carbon steel, brass, silver foils, gold foils, and the like may be employed. For a specific printing application, the end user may have a desirable color range of choice. For the printing media in the current teaching, the media color is mainly dependent on the color of the lustrous metallic core substrate 102. In another words, the balance between the reflection and absorption of photons may determine how white or how gray the lustrous metallic core substrate 102 looks. In other examples, the copper foils or gold foils can be selected. These lustrous metallic core substrates can present as either a reddish-like copper core substrate or a yellowish-like gold core substrate, respectively. In another example, silver foil may be selected, in which the limiting frequency is in the far UV, and the substrate may appear as one of the whitest in lustrous metallic appearance.

In yet another example, the color of the printing media may not be largely decided by lustrous metallic core substrate but mainly attributed to the L*a*b* value of ink set used, and the optic function of the lustrous metallic core substrate is to provide a lustrous appearance. For example, the white lustrous metallic core substrate may be a whiteish-appearing aluminum foil, printed with an ink set of yellow with L*a*b* coordinates such as L*=85-87, a*=2.5-7.5, and b*27-32. The resulting combination may have a golden appearance, created at low material cost.

There is no specific limitation on the thickness of the lustrous metallic core substrate. In some examples, the thickness may be selected to ensure a good operation for printing, for example, from 0.005 inch to 0.1 inch. Some commercial products can be selected for use with the current teachings herein. For example, 1000, 2000, 3000, 5000, 6000, 8000 series aluminum foils, 102 and 110 series copper foils, 304, 309 and 321 stainless steel foils, 260 brass foils, 201 nickel foils, and 1008 and 1010 carbon steel foils may be used, all of which may be provided by ALL Foils Inc. (Strongsville, Ohio).

### Base Layer 104, 104′:

Between the lustrous metallic core substrate 102 and the image-receiving layer 106, 106′, a thin coating layer known as a base layer 104, 104′ may be applied.

Without being linked by any theory, it is believed that the base layer 104, 104′ is able to provide better adhesion between the lustrous metallic core substrate 102 and a subsequent material layer applied thereon, such as the image-receiving layer 106, 106′. The base layer may also function as an ink colorant fixation layer where the dispersed ink pigment colorants are crashed out from ink vehicle and bonded via ionic force by metallic ions within the layer. In addition, the base layer may be employed in optimizing the luster of the final lustrous print media 100.

The base layer 104, 104′may include a film-forming polymeric material such as various polyacrylates, various polymethacrylates, polyethyleneoxides, polyvinyl alcohols, polyethylene terephthalates, polyamides, polycarbonates, polystyrenes, polychloropropenes, polyoxyethylenes, poly(2-vinyl pyridine), epoxy resins, or a combination or mixture of two or more of these materials. In some examples, the polymeric material of the base layer 104, 104′ may be a copolymer emulsion of butyl acrylate-ethyl acrylate.

The base layer 104, 104′ may also include a multivalent metal ion which is divalent or greater and is part of a metallic salt. The metallic salt may include, but is not limited to, water-soluble multivalent metallic salts. In some examples, the metallic salt may include metal cations, such as Group II metals, Group III metals, and transition metals, and combinations of two or more thereof Specific examples of the metals may include, but are not limited to, calcium, copper II, nickel, magnesium, zinc, barium, iron, aluminum, and chromium.

The multivalent metal ion may further include a counter ion, the nature of which depends on the nature of the multivalent metal ion, for example. The combination of multivalent metal ion and counter ion forms the metallic salt, which in many examples is water-soluble. Specific examples of counter ions for multivalent metal ions may include, but are not limited to, halogen anions, such as chloride, bromide and iodide; carboxylic acid anions, such as acetate; phosphoric acid anion; sulfuric acid anion (sulfates); sulfites; phosphates; chlorates; phosphonium halide salts, such as hexafluorophosphorus anions; tetraphenyl boronic anions; perchlorates; nitrates; phenolates, or a combination of two or more thereof In some examples, the multivalent metal salt may be, but is not limited to, one or more of aluminum nitrate, calcium chloride, magnesium nitrate, and salts of organic acids.

An amount of the multivalent metal ion in the base layer may be dependent, for example, on one or more of the nature of the multivalent ion, the nature of the anion, the nature and type of the film-forming polymer, and the nature of the printing ink. For example, the amount of multivalent ion in the base layer may be within a range of about 0.05 wt % to about 20 wt %. In some examples, the amount of the multivalent metal ion in the print medium surface treatment may be within a range of about 0.5 wt % to about 8 wt %.

Optionally, the base layer may include a non-porous inorganic pigment filler in an amount of about 5 wt % up to about 30 wt % of the total base layer. Examples of filler may include, but are not limited to, calcium carbonate (ground (GCC) or precipitated (PCC)), aluminum silicate, mica, magnesium carbonate, silica gel, alumina, boehmite, talc, kaolin clay, or calcined clay, or combinations of two or more of any of the above. The amount of filler may be directly related with lustrous properties. An excessive amount may decrease the degree of luster but an inadequate amount may cause low adhesion and poor colorant fixation.

An amount of the base layer 104, 104′ material on the lustrous metallic core substrate 102 may be within a range of about 0.01 grams per square meter (gsm; g/m²) to about 5 gsm. In some examples, the amount of the base layer material applied over the lustrous metallic core substrate may be within a range of about 0.1 gsm to about 5 gsm, or about 0.3 gsm to about 4 gsm, or about 0.5 gsm to about 3 gsm. The thickness of the base layer 104, 104′ may be within a range of about 0.01 micrometers (μm, 10⁻⁶ m) to about 5 μm or in the range of about 0.2 μm to about 0.5 μm.

In some examples, before applying any coating 104, 104′ to the lustrous metallic core substrate 102, a corona treatment may be done in order to remove any oxides on the surface of the lustrous metallic core substrate. The lustrous metallic core substrate 102 can thus be pre-treated in a corona chamber at room temperature and atmospheric pressure. In another implementation, the lustrous metallic core substrate 102 can be pre-washed with an acidic solution such as HCl or H₂SO₄ solution of 5% to 30% concentration by weight to remove the oxides and “etch” the surface to improve adhesion to the base layer 104, 104′ and image-receiving layers 106, 106′.

### Image-Receiving Layer 106, 106′:

The printing media 100 may include the lustrous metallic core substrate 102 and at least an image-receiving layer 106 may be disposed on at least one side of the substrate. In some examples, the image-receiving layer or inkjet receiving or ink recording layer or ink receiving layer 106, may be present on one side of the lustrous metallic core substrate 102. In other examples, an additional image-receiving layer 106′ may be present on the backside of the lustrous metallic core substrate 102.

The image-receiving layer 106, 106′ can be considered as a composite structure. The word “composite” refers herein to a material made from at least two constituent materials, or multiple phases, that have different physical and/or chemical properties from one another, and wherein these constituent materials/ multiple phases remain separate at a molecular level and distinct within the structure of the composite.

The image-receiving layer 106 may be disposed on one side of the lustrous metallic core substrate 102 and can form a layer having a coat-weight within a range of about 0.5 gsm to about 30 gsm, or within a range of about 1 gsm to about 20 gsm, or within a range of about 1 gsm to about 15 gsm. In some examples, the printable media 100 may have an ink-receiving layer 106 that is applied to only one side of the lustrous metallic core substrate 102 and that has a coat-weight in the range of about 2 gsm to about 10 gsm. In other examples, the printable recording media 100 may contain image-receiving layers 106, 106′ that are applied, each to one side of the lustrous metallic core substrate 102 and that have a coat-weight in the range of about 1 gsm to about 10 gsm per side.

The image-receiving layer 106, 106′ may include nano-sized inorganic pigment particles, an electrically charged substance and, at least, a polymeric binder. There are two primary functions that may be attributed to nano-sized inorganic pigment particles, where these particles or the aggregated particles (secondary particles) may have the capability to form an absorption layer to accommodate the ink colorants and ink vehicles (solvents), and these particles or the aggregated particles may also play a role to defuse the strong reflection from the surface of lustrous metallic core substrate. In some examples, the lustrous metallic core substrate 102 may reflect photons to show the metallic luster, but this refection may be limited to within a certain range, namely, the luster level S value of the lustrous print media 100 may be within a range of 6.5 to 10.5, i.e., after the layers 104, 106 are applied. Otherwise, if the reflection is too high, a “too-flushed” luster image, e.g., too shiny or glossy, can be produced, which may be difficult to see. On the other hand, if the reflection is too low, then a matte appearance of the image may be perceived. Depending on the particle size, distribution of the particle size, volume percentage of aggregated particles including secondary particles of nano-sized inorganic pigment particles, and coat weight, there may be a specific size of nano-sized inorganic pigment particles used in image-receiving layer, in an example. That is to say, particle size may be used to control the amount of reflection. While the particle size of the nano-particles may be in the nanometer (nm) range (see below), in another example, larger particle sizes may be used in conjunction with the nanoparticles to further reduce reflection. To diffuse reflection, the larger particles may be in the range of about 0.5 μm to about 10 μm.

By “nano-sized” pigment particles, it is meant herein pigments, in the form of particles, that have an average particle size that is in the nanometer (nm, 10⁻⁹ meters) range. The particles may be either substantially spherical or irregular. In some examples, the inorganic pigment particles may have an average particle size within a range of about 1 nm to about 150 nm; in other examples, the inorganic pigment particles may have an average particle size within a range of about 2 nm to about 100 nm.

In some examples, the surface area of the inorganic pigment particles may be in the range of about 20 m²/g to about 800 m²/g or in the range of about 25 m²/g to about 350 m²/g. The surface area can be measured, for example, by adsorption using a BET (Brunauer-Emmet-Teller) isotherm. In some examples, the inorganic pigment particles may be pre-dispersed in a dispersed slurry form before being mixed with the composition for coating on the substrate. An alumina powder can be dispersed, for example, with a high share rotor-stator type dispersion system such as an ystral system, available from ystral, Germany.

In some examples, the image-receiving layer 106, 106′ may contain from about 40 wt % to about 95 wt % of nano-size inorganic pigment particles by total weight of the layer. In other examples, the image-receiving layer 106, 106′ may contain from about 65 wt % to about 85 wt % of nano-size inorganic pigment particles by total weight of the layer. In some examples, the nano-size inorganic pigment particles of the image-receiving layer 106, 106′ may be metal oxide or complex metal oxide particles. As used herein, the term “metal oxide particles” encompasses metal oxide particles or insoluble metal salt particles. Metal oxide particles are particles that may have high refractive index (i.e., greater than 1.65) and that may have a particle size in the nano-range such that they are substantially transparent to the naked eye. The visible wavelength is in the range from about 400 nm to about 700 nm.

Examples of inorganic pigments may include, but are not limited to, titanium dioxide, hydrated alumina, calcium carbonate, barium sulfate, silica, high brightness alumina silicates, boehmite, pseudo-boehmite, zinc oxide, kaolin clays, and/or combinations thereof The inorganic pigment can include clay or a clay mixture. The inorganic pigment filler can include a calcium carbonate or a calcium carbonate mixture. The calcium carbonate may be one or more of ground calcium carbonate (GCC), precipitated calcium carbonate (PCC), modified GCC, and modified PCC. The inorganic particles can also be chosen from aluminum oxide (Al₂O₃), silicon dioxide (SiO₂), nanocrystalline boehmite alumina (AlO(OH)) and aluminum phosphate(AlPO₄). Examples of such inorganic particles may be Disperal® HP-14, Disperal® HP-16, and Disperal® HP-18, available from Sasol Co., Johannesburg, South Africa.

The nano-size inorganic pigment particles may also be a “colloidal solution” or “colloidal sol”. Such a colloidal sol is a composition of nano-size particles with a metal oxide structure in a liquid. Examples of the metal oxide may include aluminum oxide, silicon oxide, zirconium oxide, titanium oxide, calcium oxide, magnesium oxide, barium oxide, zinc oxide, boron oxide, and mixture of two or more metal oxides. In some examples, the colloidal sol may be a mixture of about 10 wt % to about 20 wt % of aluminum oxide and about 80 wt % to about 90 wt % of silicon oxide. In a specific example, the colloidal sol may be a mixture of about 14 wt % of aluminum oxide and about 86 wt % of silicon oxide. The nano-size inorganic pigment particles can be, in an aqueous solvent, either cationically or anionically charged and stabilized by various opposite charged groups such as chloride, sodium, ammonium, and acetate ions. Examples of colloidal sols that are commercially available may include those under the tradename Nalco®8676, Nalco® 1056, or Nalco 1057, as supplied by NALCO Chemical Company; or those under the tradename Ludox®/Syton®, such as Ludox® HS40 and HS30, TM/SM/AM/AS/LS/SK/CL-X and Ludox® TMA from Grace, Inc.; or those under the name Ultra-Sol 201A-280/140/60 from Eminess Technologies, Inc.

The colloidal sol can also be prepared by using particle agglomerates which have the chemical structure as described above but which have starting particles size in the range of about 5 μm to about 10 μm. Such colloidal sols can be obtained by breaking agglomerates using chemical separation and mechanical shear force energy. Monovalent acids such as nitric, hydrochloric, formic or acetic with a PKa value of 4.0 to 5.0 can be used. Agglomerates are commercially available, for example, from Sasol, Germany under the tradename of Disperal® or from Dequenne Chimie, Belgium under the tradename Dequadis®HP.

With regard to the nano-size inorganic pigment particles, to control the degree of lustrous reflection, the image-receiving layer 106, 106′ may further include second particles that have a size range that is significantly, or at least 20 to 500 times larger, than the first nano-particles (i.e., the nano-size inorganic pigment particles). Such second particles may be added depending on the gloss level required for the print media 102. The particles may be, for example, ground calcium carbonate such as Hydrocarb® 60 available from Omya, Inc.; precipitated calcium carbonate such as Opacarb®A40 or Opacarb®3000 available from Specialty Minerals Inc. (SMI); clay such as Miragloss® available from Engelhard Corporation; synthetic clay such as hydrous sodium lithium magnesium silicate, such as, for example, Laponite® available from Southern Clay Products Inc.; and titanium dioxide (TiO₂) available from, for example, Sigma-Aldrich Co. The second type of the particles can be other kinds of particles or pigments than the first type. Examples of secondary inorganic particles may include, but are not limited to, particles, either existing in a dispersed slurry or in a solid powder, of polystyrene and its copolymers, polymethacrylates and their copolymers, polyacrylates and their copolymers, polyolefins and their copolymers, such as polyethylene and polypropylene, or a combination of two or more of the polymers. The second inorganic particles may be chosen from silica gel (e.g., Silojet®703C available from Grace Co.), modified (e.g., surface modified, chemically modified, etc.) calcium carbonate (e.g., Omyajet®B6606, C3301, and 5010, all of which are available from Omya, Inc.), precipitated calcium carbonate (e.g., Jetcoat®30 available from Specialty Minerals, Inc.), and combinations thereof.

In addition to the nano-size inorganic pigment particles, the image-receiving layer 106, 106′ may contain at least one polymeric binder. Without being linked by any theory, it is believed that the polymeric binder may be used to provide adhesion among the inorganic particles within the image-receiving layer 106, 106′. The polymeric binder may also be used to provide adhesion between the image-receiving layer 106, 106′ and the underlying base layer 104. In some examples, the polymeric binder may be present in the image-receiving layer 106, 106′ in an amount representing from about 5 parts by dry weight to 25 parts by dry weight per 100 parts of nano particles.

The polymeric binder can be either a water-soluble substance (synthetic or natural) or an aqueous-dispersible substance, such as a polymeric latex. The binder may be chosen from water-soluble binders and water-dispersible polymers that exhibit high binding power for base paper stock and pigments, either alone or as a combination. By “high binding power” is meant the ability of the binder to withstand a peeling strength test. The lower the glass transition temperature (T_{g}), the better. However, if the T_{g} is too low, then the binder may become too soft. In some examples, the polymeric binder components may have a glass transition temperature (T_{g}) ranging from −10° C. to +50° C. The way of measuring the glass transition temperature (T_{g}) parameter is described in, for example, Polymer Handbook, 3rd Edition, authored by J. Brandrup, edited by E. H. Immergut, Wiley-Interscience, 1989.

As mentioned above, suitable binders may include, but are not limited to, water-soluble polymers and water-dispersible polymers. Examples of water-soluble polymers may include polyvinyl alcohol, starch derivatives, gelatin, cellulose derivatives, and acrylamide polymers. Water-dispersible polymers may include acrylic polymers or copolymers, vinyl acetate latex, polyesters, vinylidene chloride latex, styrene-butadiene copolymers, and acrylonitrile-butadiene copolymers. Non-limiting examples of suitable binders may include styrene-butadiene copolymer, polyacrylates, polyvinylacetates, polyacrylic acids, polyesters, polyvinyl alcohol, polystyrene, polymethacrylates, polyacrylic esters, polymethacrylic esters, polyurethanes, copolymers thereof, and combinations thereof. In some examples, the binder may be a polymer or copolymer chosen from acrylic polymers or copolymers, vinyl acetate polymers or copolymers, polyester polymers or copolymers, vinylidene chloride polymers or copolymers, butadiene polymers or copolymers, styrene-butadiene polymers or copolymers, and acrylonitrile-butadiene polymers or copolymers. In other examples, the binder component may be a latex containing particles of a vinyl acetate-based polymer, an acrylic polymer, a styrene polymer, an SBR-based polymer, a polyester-based polymer, a vinyl chloride-based polymer, or the like. In yet other examples, the binder may be a polymer or a copolymer chosen from acrylic polymers, vinyl-acrylic copolymers and acrylic-polyurethane copolymers. Such binders can be polyvinyl alcohol or a copolymer of vinyl pyrrolidone. The copolymer of vinyl pyrrolidone can include various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, etc. Examples of binders may include, but are not limited to, polyvinyl alcohols and water-soluble copolymers thereof, e.g., copolymers of polyvinyl alcohol and poly(ethylene oxide) or copolymers of polyvinyl alcohol and polyvinyl amine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; and combinations thereof Commercial examples of binders may include Poval®235, Mowiol®56-88, and Mowiol®40-88, available from Kuraray and Clariant.

The binder may have a weight average molecular weight (Mw) of about 5,000 to about 500,000. In some examples, the binder may have an Mw ranging from about 100,000 to about 300,000. In other examples, the binder may have an Mw of about 250,000. The average particle diameter of the latex binder can be from about 10 nm to about 10 μm, and in other examples, from about 100 nm to about 5 μm. The particle size distribution of the binder is not particularly limited, and either binders having a broad particle size distribution or binders having a mono-dispersed particle size distribution may be used. The binder may include, but is not limited to latex resins sold under the name Hycar® or Vycar®, available from Lubrizol Advanced Materials Inc.; Rhoplex®, available from Rohm & Hass Company; Neocar®, available from Dow Chemical Company; Aquacer®, available from BYC Inc. or Lucidene®, available from Rohm & Haas Company.

In some examples, the binder may be selected from natural macromolecule materials such as starches, chemical or biological modified starches, and gelatins. The binder can be a starch additive. The starch additive may be of any type, including but not limited to oxidized, ethylated, cationic, and pearl starch. In some examples, the starch may be used in an aqueous solution. Suitable starches that may be employed herein are modified starches, such as starch acetates, starch esters, starch ethers, starch phosphates, starch xanthates, anionic starches, cationic starches, and the like which can be derived by reacting the starch with a suitable chemical or enzymatic reagent. In some examples, the starch additive may be a native starch, or a modified starch (enzymatically-modified starch or chemically-modified starch). In other examples, the starch may be a cationic starch or a chemically-modified starch. Useful starches may be prepared by known techniques or obtained from commercial sources. Examples of suitable starches include Penford Gum-280, available from Penford Products; SLS-280, available from St. Lawrence Starch; the cationic starch CatoSize 270, available from National Starch, and poly(acrylamide/acrylic acid) grafted starch, available from Polysciences, Inc. In some examples, a suitable size press/surface starch additive may be 2-hydroxyethyl starch ether, which is available under the tradename Penford®Gum 270, from Penford Products.

In some examples, due to a strong tendency of re-agglomeration of the nano-particles due to a change in ionic strength, the binder may be a non-ionic binder. Examples of such binders are commercially available, for example, from Dow Chemical Inc. under the tradename Aquaset® and Rhoplex® emulsions, or as polyvinyl alcohol, which is commercially available from Kuraray American, Inc., under the tradename Poval®, Mowiol® and Mowiflex®.

The image-receiving layer 106, 106′ may further include an electrically charged substance. “Electrically charged” refers to chemical substance with some atoms gaining or losing one or more electrons or protons, together with a complex ion consisting of an aggregate of atoms with the opposite charge. The electrically charged substance may be a charged ion or associated complex ion that can de-coupled in an aqueous environment. In some examples, the electrically charged substance is an electrolyte, having a low molecular weight species, such as calcium chloride or aluminum nitride or a high molecular weight species, such as poly(dialkylaminoalkyl(meth)acrylamides), poly(N-alkyl(meth)acrylamides) or poly(N,N-dialkyl(meth)acrylamides). The electrically charged substance can be present, in the image-receiving layer 106, 106′, in an amount representing from about 0.005 gsm to about 1.5 gsm of base substrate 102; or from about 0.2 gsm to about 0.8 gsm of base substrate 102 in another example.

In some examples, the electrically charged substance may be a water-soluble divalent or multi-valent metal salt. The term “water-soluble” is meant to be understood broadly as a species that is readily dissolved in water. Thus, water-soluble salts may refer to a salt that has a solubility greater than 15 g/100 g H₂O at 1 atmosphere pressure at 20° C.

The electrically charged substance may be a water-soluble metallic salt. The water-soluble metallic salt may be an organic salt or an inorganic salt. The electrically charged substance may be an inorganic salt; in some examples, the electrically charged substance may be a water-soluble and multi-valent charged salt. Multi-valent charged salts may include cations, such as Group I metals, Group II metals, Group III metals, or transition metals, such as sodium, calcium, copper, nickel, magnesium, zinc, barium, iron, aluminum, and chromium ions. The associated complex ion may be chloride, iodide, bromide, nitrate, sulfate, sulfite, phosphate, chlorate, or acetate ion.

The electrically charged substance can be an organic salt; in some examples, the electrically charged substance may be a water-soluble organic salt; in other examples, the electrically charged substance may be a water-soluble organic acid salt. The term “organic salt” may refer to an associated complex ion that is an organic species, where cations may or may not the same as inorganic salt-like metallic cations. Organic metallic salts are ionic compounds composed of cations and anions with a formula such as (CₙH₂ₙ₊₁COO-M⁺)*(H₂O)ₘ where M⁺ is a cation species including Group I metals, Group II metals, Group III metals, and transition metals such as, for example, sodium, potassium, calcium, copper, nickel, zinc, magnesium, barium, iron, aluminum, and chromium ions. Anion species can include any negatively charged carbon species with a value of n from 1 to 35. The hydrates (H₂O) may be water molecules attached to salt molecules with a value of m from 0 to 20. Examples of water-soluble organic acid salts may include metallic acetate, metallic propionate, metallic formate, and the like. The organic salt may include a water-dispersible organic acid salt. Examples of water-dispersible organic acid salts may include a metallic citrate, metallic oleate, metallic oxalate, and the like.

In some examples, the electrically charged substance may be a water-soluble, divalent or multi-valent metal salt. Specific examples of the divalent or multi-valent metal salt used in the coating may include, but are not limited to, calcium chloride, calcium acetate, calcium nitrate, calcium pantothenate, magnesium chloride, magnesium acetate, magnesium nitrate, magnesium sulfate, barium chloride, barium nitrate, zinc chloride, zinc nitrate, aluminum chloride, aluminum hydroxychloride, and aluminum nitrate. Divalent or multi-valent metal salt may also include CaCl₂, MgCl₂, MgSO₄, Ca(NO₃)₂, and Mg(NO₃)₂, including hydrated versions of these salts. In some examples, the water soluble divalent or multi-valent salt can be chosen from calcium acetate, calcium acetate hydrate, calcium acetate monohydrate, magnesium acetate, magnesium acetate tetrahydrate, calcium propionate, calcium propionate hydrate, calcium gluconate monohydrate, calcium formate, and combinations thereof In some examples, the electrically charged substance may calcium chloride and/or calcium acetate. In other examples, the metal salt may be calcium chloride.

In addition to the above-described components, the image-receiving layer 106, 106′ formulations may also contain other components or additives, as necessary, to carry out the required mixing, coating, manufacturing, and other process steps, as well as to satisfy other requirements of the finished product, depending on its intended use. The additives may include, but are not limited to, one or more of rheology modifiers, thickening agents, cross-linking agents, surfactants, defoamers, optical brighteners, dyes, pH-controlling agents or wetting agents, and dispersing agents, for example. The total amount of additives, in the composition for forming the image-receiving layer, can be from about 0.1 wt % to about 10 wt % or from about 0.2 wt % to about 5 wt %, by total dry weight of the image-receiving layer 106, 106′.

### Back Supporting Layer 108:

In an example, the back supporting layer 108 may formed on the opposite side of the image-receiving layer 106. The back supporting layer 108 may include a cellulose paper laminated with a polyacrylate lamination glue. The function of the back supporting layer 108 is to prevent any mechanical scratch to the lustrous metallic core substrate and may also provide a pen-writeable surface on the back of the printing media 100. The cellulose paper may be any kind of the paper, colored or white, with basis weight from 60 gsm to 250 gsm. The back supporting layer 108 may be omitted if a base layer 104′ and an ink receiving layer 106′ are formed on the backside of the lustrous metallic core substrate 102, as described above.

### Formation of the Lustrous Print Media:

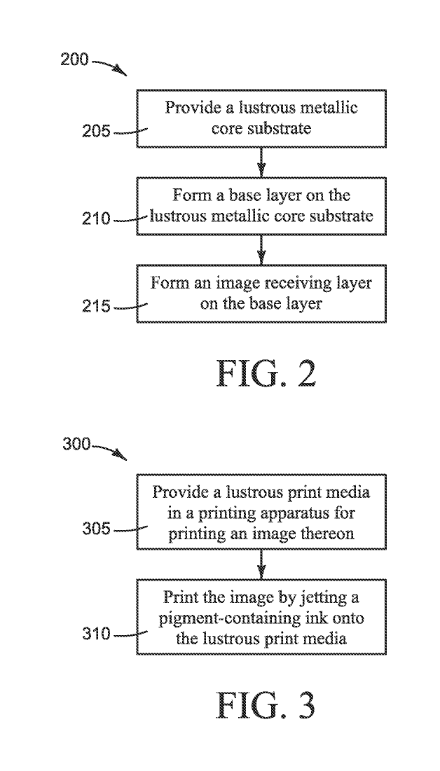

The various layers 104, 104′, 106, 106′, 108 may be formed on the layers beneath them by analog processes such as Mayer rod coating, curtain coating, knife coating, roller coating, spray coating, slot die coating, etc. FIG. 2 depicts an example method 200 for fabricating a lustrous print media 100. The method 200 may include providing 205 the lustrous metallic core substrate 102. The method 200 may further include forming 210 the base layer 104 on the lustrous metallic core substrate 102. The method 200 may conclude with forming 215 the image-receiving layer 106 on the base layer 104.

As described above, the method may further include forming the laminated back supporting layer 108 on the backside of the lustrous metallic core substrate 102. Alternatively, as described above, the method may further include forming the second base layer 104′ on the backside of the lustrous metallic core substrate 102 and forming the second image-receiving layer 106′ on the second base layer 104′.

Whether forming the base layer 104 on one side of the lustrous metallic core substrate 102 or additionally forming the second base layer 104′ on the other side of the lustrous metallic core substrate, the lustrous metallic core substrate may be subjected to a cleaning to remove any oxides on a surface of the lustrous metallic core substrate. The cleaning may be by corona discharge or acid wash.

### Printing on the Lustrous Print Media:

Printing on the lustrous print media may be accomplished by inserting the lustrous print media in an appropriate printing apparatus for printing images. For example, an inkjet printer, such as a thermal inkjet printer, may be used to print the images.

FIG. 3 depicts an example method 300 for printing an ink on the lustrous print media 100. The method 300 may include providing 305 the lustrous print media in a printing apparatus for printing an image thereon. The method 300 may conclude with printing the image by jetting a pigment-containing ink onto the lustrous print media 100.

As described above, in cases where the lustrous print media 100 has two image-receiving layers, 106 and 106′, ink may be printed on one or both of the image-receiving layers 106, 106′.

### EXAMPLES

A special lustrous print media 100 was prepared for illustration purposes. A 0.012 inch thick aluminum foil was used as lustrous metal substrate 102. The formulations of the base layer 104, image-receiving layer 106, and lamination glue are listed in Table I below. A 120 gsm wood-free white paper was laminated at the backside of the media 100 to form the back supporting layer 108. The gold image and lustrous image were created using a HP® Photosmart 7640 desk-top printer with the paper selector set to HP® Photo Paper. The various layers were applied with a Mayer rod method. However, production scale application may be done with curtain coating.

TABLE I
Composition of Layers (Values Are Parts by Weight).

| | | Image- | |
|---|---|---|---|
| | Base Layer | Receiving | Lamination |
| Chemicals¹ | 104 | Layer 106 | Glue |
| Rovene ® 4017 | 100 | | |
| Hydrocarb ® 60 | 15 | | |
| HP 14 dispersion | | 100 | |
| Mowiol ® 40-98 | | 25 | |
| Mowiol ® 6-98 | | 3 | |
| CaCl₂ | 5 | 5 | |
| Sai De SD690 powder | | 5 | |
| Silwet ® L-7657 | | 2 | |
| BYK-024 | | 1 | |
| Irgalite ® Violett | | 0.01 | |
| Irgalite ® Blau | | 0.022 | |
| Joncryl ® FLX 5000 | | | 100 |
| Hydrocab ® 60 | | | 75 |
| BYK-Dynwet 800 | | | 1 |

Notes:
¹Sources for the chemicals listed in Table I that are not given elsewhere herein are as follows: Rovene ® 4017 is available from Mallard Creek Polymers; SD690 is available from Sai De, Beijing, China; Silwet ® L-7657 is available from Momentive Performance Materials, Waterford, NY; BYK-024 and BYK-Dynwet 800 are available from Geretsried, Germany; Irgalite ® Violett and Blau and Joncryl ® are available from BASF, Southfield, MI.

A comparison study was conducted, in which the print medium prepared having the image-receiving layer 106 indicated in Table I was denoted as Example (Ex.) 1. Comparative (Comp.) Examples 2-6 had differences, such as in the dispersed particle size for the image-receiving layer 106, the presence or absence of a base layer 104 and the coat weight of the image receiving layer 106. The results are tabulated in Table II below.

TABLE II
Comparison Study on Image-receiving Layer (Values Are Parts by Weight)

| | | Ex. 2 | Ex. 3 | Ex. 4 | Ex. 5 | Ex. 6 |
|---|---|---|---|---|---|---|
| Chemicals¹ | Ex. 1 | (Comp.) | (Comp.) | (Comp.) | (Comp.) | (Comp.) |
| HP 14 | 100* | 100* | 100* | — | 100* | 80* |
| dispersion | | | | | | |
| Gasil ® 23F | | | | 100** | | |
| Mowiol ® 40-98 | 25 | 25 | 25 | 25 | 25 | 25 |
| Mowiol ® | 3 | 3 | 3 | 3 | 3 | 3 |
| 6-98 | | | | | | |
| CaCl₂ | 5 | 5 | 5 | 5 | 5 | 5 |
| SaiDe SD690 | 5† | 5† | 5† | 5† | 0 | 20† |
| powder | | | | | | |
| Silwet ® L- | 2 | 2 | 2 | 2 | 2 | 2 |
| 7657 | | | | | | |
| BYK-024 | 1 | 1 | 1 | 1 | 1 | 1 |
| Irgalite ® | 0.01 | 0.01 | 0.01 | 0.01 | 0.01 | 0.01 |
| Violett | | | | | | |
| Irgalite ® | 0.022 | 0.022 | 0.022 | 0.022 | 0.022 | 0.022 |
| Blau | | | | | | |
| Base layer | yes | yes | no | yes | yes | yes |
| 104 | | | | | | |
| Coat weight | 10 gsm | 30 gsm | 10 gsm | 10 gsm | 10 gsm | 10 gsm |
| Test results | Excellent | Excellent PQ, | Average PQ | Good PQ, | Good to | Good PQ, |
| (PQ = print | PQ, strong | good image | with small | and good | excellent PQ, | and good |
| quality) | lustrous | durability but | coating | image | (due to too | image |
| | appearance | poor lustrous | cracking, | durability but | strong | durability but |
| | and good | appearance | strong | poor lustrous | lustrous | poor lustrous |
| | image | | lustrous | appearance | image, some | appearance |
| | durability | | appearance, | | evaluators | |
| | | | very poor | | gave lower | |
| | | | image | | score to PQ). | |
| | | | durability | | Good image | |
| | | | | | durability | |

Notes:
*Dispersed particle size 120 nm.
**Dispersed particle size 4.7 μm.
†Dispersed particle size 6 to 8 μm.
¹Sources for the chemicals listed in Table II that are not given elsewhere herein are as follows: Gasil ® 23F is available from PQ Corporation, Valley Forge, PA.

It can be seen from the Examples that the base layer 104 improved the coating adhesion. For example, omitting the base layer (Example 3) resulted in “very poor image durability”, which means poor coating adhesion. It can also be seen that large particle sizes (e.g., 4.7 μm) reduced lustrous appearance (see Example 4). On the other hand, an appropriate addition of secondary particles helped to balance the lustrous level, such as the case of Example 1.

What is claimed is:

1. Lustrous print media, including:
a lustrous metallic core substrate;
a base layer disposed on the lustrous metallic core substrate; and
an image-receiving layer disposed on the base layer.

2. The lustrous print media as defined in claim 1, further including:
a laminated back supporting layer disposed on the backside of the print media.

3. The lustrous print media as defined in claim 1, wherein the lustrous metallic core has a front side and a backside, with a first base layer and a first image-receiving layer disposed on the front side and wherein the lustrous print media further includes:
a second base layer disposed on the backside of the lustrous metallic core substrate; and
a second image-receiving layer disposed on the second base layer.

4. The lustrous print media as defined in claim 3, wherein the lustrous metallic core substrate has a Luster S value of at least 6.5, where S is determined by 3(L1-L3)/L2, where S is the measured luster, L1 is CIELAB L* measured at the aspecular angle of 15 degrees, L2 is CIELAB L* measured at the aspecular angle of 45 degrees, and L3 is CIELAB L* measured at the aspecular angle of 110 degrees.

5. The lustrous print media as defined in claim 1, wherein the base layer includes:
a film-forming polymeric material; and
a metallic salt composed of a multivalent metal ion that is divalent or greater and a counter ion.

6. The lustrous print media as defined in claim 5, wherein the film-forming polymeric material is chosen from polyacrylates, polymethacrylates, polyethyleneoxides, polyvinyl alcohols, polyethylene terephthalates, polyamides, polycarbonates, polystyrenes, polychloropropenes, polyoxyethylenes, poly(2-vinyl pyridine), epoxy resins, and a combination or mixture of two or more of the polymeric materials.

7. The lustrous print media as defined in claim 5, wherein the base layer further includes:
a non-porous inorganic pigment filler in an amount of about 5 wt % up to about 30 wt % of the total base layer.

8. The lustrous print media as defined in claim 1, wherein the image-receiving layer includes:
nano-sized inorganic pigment particles;
an electrically charged substance; and
a polymeric binder.

9. The lustrous print media as defined in claim 8, wherein the image-receiving layer further includes inorganic pigment particles that are 20 to 500 times larger than the nano-sized inorganic pigment particles, to control the degree of lustrous reflection.

10. A method for fabricating a lustrous print media, the method including:
providing a lustrous metallic core substrate;
forming a base layer on the lustrous metallic core substrate; and
forming an image-receiving layer on the base layer.

11. The method as defined in claim 10, further including forming a laminated back supporting layer on the backside of the print media.

12. The method as defined in claim 10, wherein the lustrous metallic core has a front side and a backside, with a first base layer and a first image-receiving layer disposed on the front side, the method further including:
forming a second base layer on the backside of the lustrous metallic core substrate; and
forming a second image-receiving layer on the second base layer.

13. The method as defined in claim 10, wherein the lustrous metallic core substrate is subjected to a cleaning to remove any oxides on a surface of the lustrous metallic core substrate prior to forming the base layer.

14. A method for printing an ink on a lustrous print media, the lustrous print media including a lustrous metallic core substrate; a base layer disposed on the lustrous metallic core substrate; and an image-receiving layer disposed on the base layer, the method including:
providing the lustrous print media in a printing apparatus for printing an image thereon; and
printing the image by jetting a pigment-containing ink onto the lustrous print media.

15. The method as defined in claim 14, further including:
providing a lustrous print media having the lustrous metallic core substrate;
another base layer on another side of the lustrous metallic core substrate; and another image-receiving layer on the base layer, wherein ink is printed on the another image-receiving layer.
